(19) United States
(12) Patent Application Publication
(10) Pub. No.: US 2012/0041796 A1
(43) Pub. Date: Feb. 16, 2012

(54) TECHNICAL MATURITY MANAGEMENT SYSTEM

(75) Inventors: John R. MILLER, JR., Vestal, NY (US); Joel Dean Anderson, Marietta, GA (US); Mark A. Gaug, Vestal, NY (US); Edward H. Szostak, Cherry Hill, NJ (US)

(73) Assignee: LOCKHEED MARTIN CORPORATION, Bethesda, MD (US)

(21) Appl. No.: 13/208,307

(22) Filed: Aug. 11, 2011

Related U.S. Application Data
(60) Provisional application No. 61/373,159, filed on Aug. 12, 2010.

(51) Int. Cl. G06Q 10/00

(52) U.S. Cl. 705/7.15

(57) ABSTRACT

A system is provided to display the technical status of a program and provide quick access to the program information. The system may include milestone views, links to work products and schedule data, links to templates, specification, requirements, review criteria, links to event maturity criteria, and displays of technical maturity assessments. The system may be provided at an enterprise level in HTML form to access criteria for tailoring individual programs. The system may be downloadable to a program server from an enterprise server to provide the foregoing capabilities. The system may be configured to import specific program information from program master schedules in order to populate milestone views, assessment views, and search engines. The system may be configured to provide access control with user privileges, defined for each user.

### CROSS-REFERENCE TO RELATED APPLICATIONS

This application claims priority to U.S. Provisional Patent Application Ser. No. 61/373,159 filed Aug. 12, 2010, which is incorporated herein by reference in its entirety.

### BACKGROUND

Businesses have experienced programs that fall behind schedule and exceed budget requirements, sometimes called “red programs,” due to lack of access to standard criteria to guide work product development and system design. Work product can take many forms including plans, specifications, trade studies, concept and design documents, schematics, annotated software code, and test reports. Proposal estimates often lack plans which define a list of standard design tasks and work products and more often lack work product standard criteria and standard design maturity criteria. Lack of these criteria can result in work products that have to be modified later in the life cycle and at much greater expense to meet defined requirements. These criteria should be defined in the planning phase. Standard design maturity criteria are also lacking for major development milestones in a life cycle.

Even though processes and standards for development may have been defined in documents for many years, accessing these documents is usually difficult and discouraging. There is lack of interactive guidance to lead a person to the correct document and section in a document which is relative to their development needs. Time and budget are also wasted to develop the work products and design without standard criteria for guidance. Subjectivity is used to evaluate and status the progressive maturity of work products versus specific criteria. Also, frequent status meetings are scheduled, which take time for preparation and presentation.

Assessments on the progress of work product development and design maturity are frequently subjective. Technical issues and risks often are not realized until it is too late to take proactive action. Lack of access to the assessment criteria and lack of access to the progressive status of the work product and design throughout the program life cycle are major problems to overcome for a program to be successful.

### SUMMARY

The subject technology addresses the foregoing problem of accessing criteria, providing quality assessments based on the criteria and accessing the assessment status on a 24/7 basis. According to certain aspects of the subject technology, a system is provided for defining a method or concept to access criteria efficiently to use as a guide for work product and design development. The same criteria may be used to perform and document quality assessments. An interactive user interface is provided to quickly review the assessment status of a rollup of work products and design per milestone events throughout the life cycle of a project. The system further provides quick access to project product standards, examples, templates, and requirements comprising the command media.

According to one aspect of the subject technology, a web-based visualization tool is provided to display the maturity status of a program and provide quick access to the program information. The tool may include milestone views, links to work products and schedule data, links to command media (templates, guidance docs, etc.), links to event maturity criteria, and displays of maturity assessments. The tool may be provided at an enterprise level in hypertext markup language (HTML) form to access criteria for tailoring individual programs. The tool may be downloadable to a program server from an enterprise server to provide the foregoing capabilities. The tool may be configured to import specific program information from program master schedules in order to populate milestone views, assessment views, and search engines. The tool may be configured to provide access control with user privileges, defined for each user. Users may include administrators, assessors, practitioners, and stakeholders (management, customers, etc.). The servers may be maintained under IT configuration management control and backed up daily.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

According to one embodiment a system for technical maturity management is provided that comprises a web based hierarchical project evaluation application. The web based hierarchical project evaluation application has a project milestone display, a hierarchical display for a plurality of project tasks, and a work product status viewer. The project milestone display has a plurality of rows of project tasks and a plurality of columns of project milestones. A status indicator provides a technical status that indicates a technical completion level of the project task for each applicable project milestone. A hyperlink is provided for each project task to provide additional information about the task. The hierarchical display for the plurality of project tasks shows the project tasks and tasks are expandable to show lower level tasks associated with the project task. Each of the project tasks has a technical status indicator to provide the technical completion level of the project task. A hyperlink being provided for each project task to provide additional information regarding the task. The work product status viewer for each of the plurality of project tasks provides technical assessment status information.

According to another embodiment, a system for providing a hierarchical project technical evaluation tool comprises an application for obtaining technical assessment data, a hierarchical project evaluation tool application, a file importation and conversion device, and a project integrated master schedule. The application obtains technical assessment data for work products of a project and stores the technical assessment data to a data repository. The hierarchical project evaluation tool application generates a project technical status based on the assessment data in the data repository. The hierarchical project technical evaluation tool application is in communication with the data repository. The file importation and conversion device is in communication with the data repository. The file importation and conversion device converts data files to a useable format within the hierarchical project evaluation tool application. The project integrated master schedule is in communication with the file importation and conversion device and provides data to the data repository for use with the hierarchical project evaluation tool application. The project integrated master schedule has a plurality of tasks to be completed for a project and a plurality of milestones for the project.

According to a further embodiment a computer-readable medium having software instructions stored thereon is provided. The software instructions, when executed by a processor, cause the processor to perform operations. A project milestone display is generated that has plurality of project tasks and a plurality of project milestones. A technical assessment for each of the project tasks is received. A technical status indicator for each of the plurality of project tasks is provided based upon the technical assessment for each of the project tasks.

### BRIEF DESCRIPTION OF THE DRAWINGS AND ATTACHMENTS

FIG. 1 depicts a home page showing a program milestone view according to an aspect of the subject technology.

FIG. 2 depicts an ICON view page according to an aspect of the subject technology.

FIG. 3 depicts a work product datasheet information view page according to an aspect of the subject technology.

FIG. 4 depicts a work product data sheet assessment view page according to an aspect of the subject technology.

FIG. 5 depicts a work product datasheet history view page according to an aspect of the subject technology.

FIG. 6 depicts a work product datasheet of work product standards (WPS) viewer page according to an aspect of the subject technology.

FIG. 7 depicts a work product datasheet WPS view templates page according to an aspect of the subject technology.

FIG. 8 depicts a work product filter view page according to an aspect of the subject technology.

FIG. 9 depicts an integrated product team (IPT) look ahead page according to an aspect of the subject technology.

FIG. 10 depicts a graphical milestone view including forecast project progress information.

FIG. 11 depicts an alternative embodiment of a home page showing a program milestone view according to another aspect of the subject technology.

FIG. 12 depicts a block diagram of a system for providing a hierarchical project evaluation tool.

FIG. 13 depicts a method for developing an interface control document (ICD).

FIG. 14 depicts a method of using a hierarchical project evaluation tool to assess work product for a task.

FIG. 15 depicts a method of using a hierarchical project evaluation tool to investigate a work product assessment for a task.

FIG. 16 depicts a method of using the hierarchical project evaluation tool to determine tasks in need of completion on a project.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

In the aerospace industry, for example, meeting program or project milestones is critical. Payments may be associated with milestones and programs/projects risk cancellation if the milestones are not met. Not surprisingly, product development teams in the aerospace industry focus on successfully completing program milestones on time, within budget and meeting all technical specifications as proven through assessments. There are many commercial-off-the-shelf program management tools used for program management and business process management. Examples of these tools include Microsoft Project, Primavera, or ARIS by IDS Scheer AG. These tools calculate critical paths, earned value, and project execution, but it often takes in-depth knowledge of the tool and analysis to determine if the program is on track to meet critical milestones. Additionally, the tool must be activated to determine the current status.

Many project members do not have the skills and patience to interpret the results from these tools especially for the project tasks that they are associated with. This means that program managers must interpret the outputs and provide feedback to team members. This detaches team members from the planned effort and from what needs to be done from an individual team member's point of view for program success.

There is also subjectivity, time lag, and duplication of effort associated with current program management tools. When a task is partially complete, usually a percent complete is entered for in-process tasks in the program management tool. To reduce the subjectivity, tasks are broken into very small pieces or a single task has non-subjective assessments assigned for certain levels of completeness. These assessments are usually entered in one system and their status (whether the work product passed its specified criteria or not) is then manually entered into the program management tool usually as just part of the status of a high level rollup task. Since this is a manual effort, there is a time lag between when an assessment is made and when it is entered into the program management system. This prevents the program management system from giving real time visibility into assessments and prevents or delays program management personnel from taking proactive actions to remedy project development maturity issues.

Project schedules entered into program management systems are composed of many tasks and work products. The tasks can be grouped in many different hierarchical structures. For instance, tasks in a schedule can be grouped in a hierarchical structure based on: Work Breakdown Structure (WBS) hierarchy, grouping of tasks in a decomposition hierarchy where the parent task is a summary of its children, program and technical milestone hierarchy, project task hierarchy, project team hierarchy, work product development hierarchy, and predecessor/successor relationship to name a few. A single task in the schedule may appear in many hierarchies. So a task called “make project outline” can appear near the top of the product hierarchy for the product project outline and possibly near the bottom of a work breakdown structure.

Project team members prefer to see the tasks they are associated with (and their associated status) in a familiar hierarchy. A project lead may want to see their tasks in a project team hierarchy or WBS hierarchy, while a product manager may want to see their tasks in a product hierarchy. Each task in a hierarchy has a status that is composed of the status of their children and their own work products. Therefore, if a WBS child task is red (meaning it did not pass an assessment, or passed its due date, or has a child task or work product that is red) the WBS parent task could also be red (depending on a defined status “rolled-up” algorithm). Since the same task has different children, depending on the hierarchy that is being viewed, the task can be one status in one hierarchy (say red) while a different status in another hierarchy, such as if the parent tasks have different scheduled completion dates.

The subject technology is designed to provide team members with the resources to accomplish their job. According to one aspect, the subject technology displays, at a glance, the program schedule in a choice of hierarchical views that individual team members are familiar and includes simple icons showing the status of whether the tasks are on track to meet project technical milestones. The subject technology may have the capability to drill down to the any actual problem areas based on the status of a particular icon. The subject technology may be fully integrated with a work product assessment tool to automatically update status based on non-subjective assessments in real time. The subject technology may have the capability to rapidly import the program integrated master schedule from a commercial Program Management Tool. The subject technology may provide access to corporate repositories of work product tools, examples, references, processes, and assessment criteria to facilitate reuse. The subject technology may be web based with the capability to be placed on the project's individual home page.

As discussed above, the subject technology is provided for the purpose of watching over the maturity development of a program, to insure that design and work product development is accomplished to meet standards for work product and design maturity criteria. Capabilities for the subject technology may be developed from a model depicting user scenarios. Users may include administrators, assessors, practitioners, stake holders and customers. Concept views of a user interface for various scenarios are described below in connection with accompanying figures.

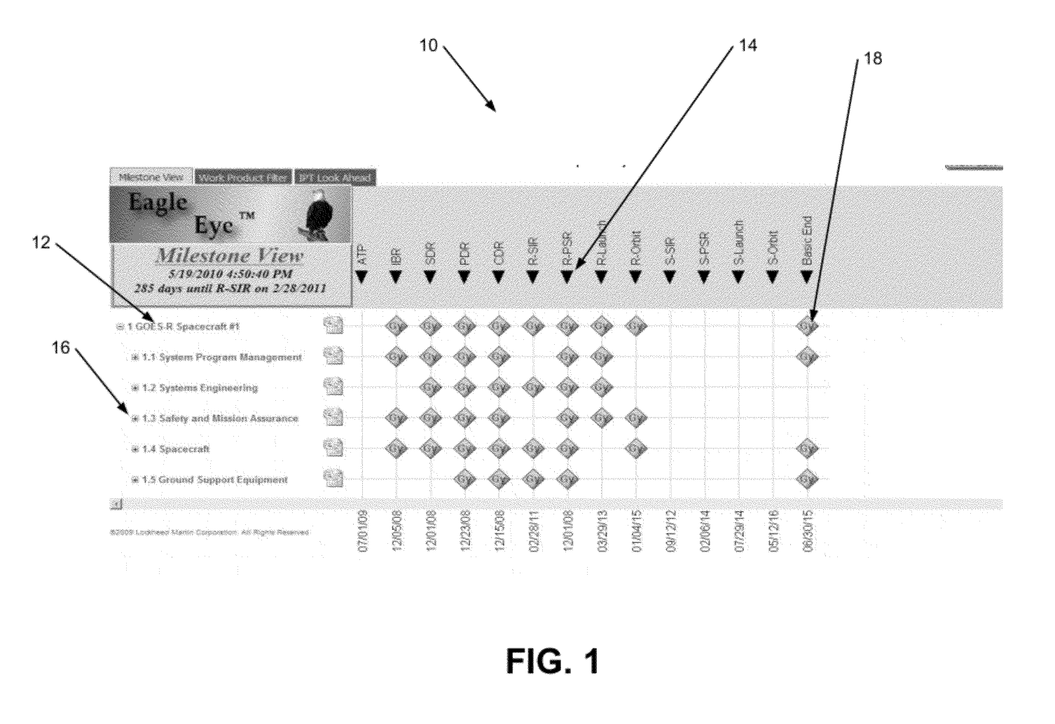

According to one aspect of the subject technology, the tool may be launched from a browser or a home page related to the program. Once launched, an HTML screen such as the one shown in FIG. 1 may be viewed by a user. The home page depicted in FIG. 1 is a program milestone view 10. The program milestone view 10 shows a number of rows of tasks or projects 12 and a number of columns of project milestones 14. Milestones 14 are shown horizontally across the top with corresponding dates across the bottom. Milestones can be programmatic or technical. Examples would be Preliminary Design Review (PDR) or Engine Design Complete. Tasks or projects 12 are shown vertically from top to bottom in a hierarchical structure of tasks, in the example illustrated this is a Work Break Down Structure format. The plus signs enable the user to further drill down to specific tasks and work products. To the right of the tasks 12 are hyperlinks to corresponding rows in the program's schedule. Both the milestones 14 and the tasks 12 may be imported from a program master schedule by a program administrator.

The rows of tasks or projects 12 are broken down into hierarchical projects 16. Each hierarchical project 16 may be further expanded into a number of tasks that define the hierarchical project 16. A status indicator 18 may be provided for each hierarchical task 16 at each applicable project milestone 14. The status indicator 18 may be color coded, such that a user is quickly made aware of the status of the hierarchical project 16 for the applicable project milestone 14. For instance, a blue status indicator 18 may indicate that a hierarchical project 16 is fully compliant with the standards for that project milestone 14, a green status indicator 18 may indicate that a hierarchical project 16 is generally compliant with the standards for that project milestone 14, a yellow status indicator 18 may indicate that a hierarchical project 16 is minimally compliant with the standards for that project milestone 14, a red status indicator 18 may indicate that a hierarchical project 16 is not compliant with the standards for that project milestone 14, and a gray status indicator 18 may indicate that no assessment has been made as to whether a hierarchical project 16 is compliant with the standards for that project milestone 14. Thus, a user is able to quickly determine the state of compliance of the hierarchical project 16.

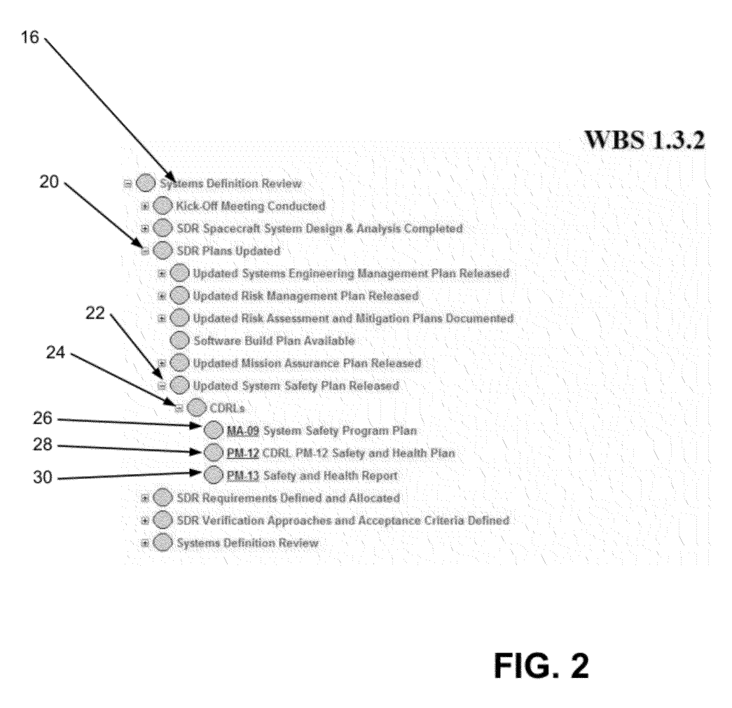

FIG. 2 depicts an icon view of an expanded view of a hierarchical project 16 showing a plurality of top level tasks 20 of the hierarchical project 16. The icon view may be automatically populated from information imported from the program master schedule. The plus signs allow the user to drill down to lower level tasks and work products. The highest level represents a top level task or milestone 20. The lowest levels are a list of work products or base-level tasks 26, 28, 30. Similar to the milestone view, the balloon colors represent the health status of each listed item. The top level tasks 20 may be made up of one or more intermediate level tasks 22. The intermediate level tasks 22 may also be hierarchical in nature and made up of sub-level tasks 24, that may be further broken up into one or more base-level tasks 26, 28, 30. Thus, a true hierarchical structure may be present for each hierarchical project 16 that can be broken down into various levels. A user may drill down from a top level task 20 to a lower level task by selecting a plus sign next to the top level task 20. Similarly, a user may also drill down from other tasks that have a lower level task by selecting the plus sign next to a task.

As shown in FIG. 2, the sub-level task 24 is broken into three base level tasks 26, 28, 30. Each base-level task 26, 28, 30 must be satisfactorily completed in order to complete the sub-level task 24. Each sub-level task 24 must be completed in order to complete an intermediate level task 22. Similarly, each intermediate level task 22 must be completed in order to complete a top level task 20. Thus, a top level task 20 will have a status indicator 18 that is representative of the lowest level status of any of its intermediate level tasks, sub-level tasks, and base-level tasks. For instance, if a top level task 20 has two intermediate level tasks, a first of which has a status indicator that is blue, and a second of which has a status indicator that is yellow, the status indicator for the top level task 20 will be yellow.

Also as shown in FIG. 2, a hyperlink may be provided for various tasks, such as base-level tasks 26, 28, 30. It is contemplated that each task and/or work product may have a hyperlink regardless of its level. It is contemplated that in other embodiments only tasks and/or work products that do not have a lower-level task may be provided with a hyperlink, and any task with a lower-level task and/or work product will simply be expandable to show the lower level tasks.

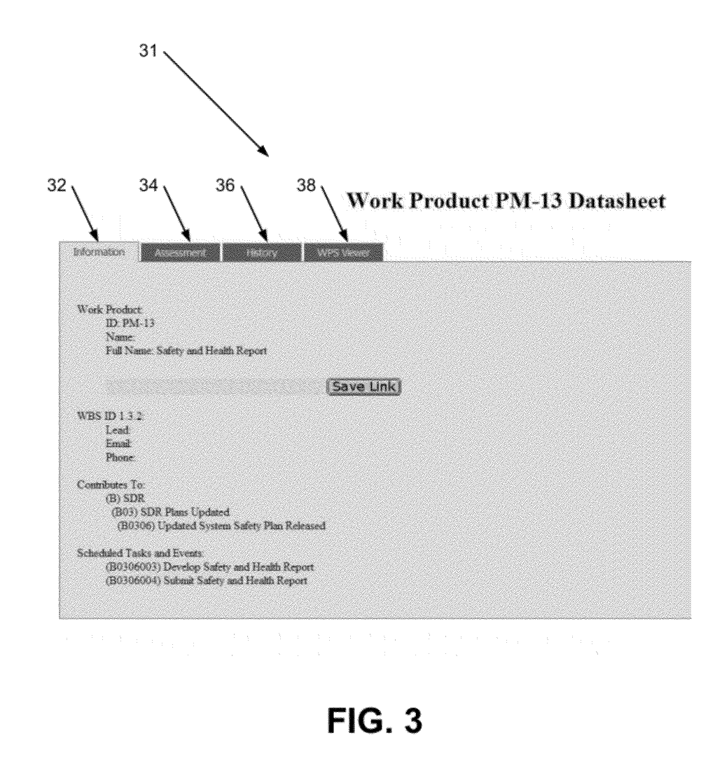

FIG. 3 depicts a work product datasheet 31 for the base-level task 30 which is displayed by the system when the hyperlink for the base level task 30 is selected by a user. The work product datasheet 31 has a number of informational tabs. For example, the work product datasheet 31 comprises an information tab 32, an assessment tab 34, a history tab 36, and a Work Product Standard (WPS) Viewer tab 38. FIG. 3 shows the work product datasheet 31 with the information tab 32 being selected. The information tab 32 displays general information related to the base-level task 30, such as a full name for the base-level task 30, contact information for a person responsible for the base-level task 30, the other tasks that base-level task 30 affects, and the scheduled events for the base-level task 30.

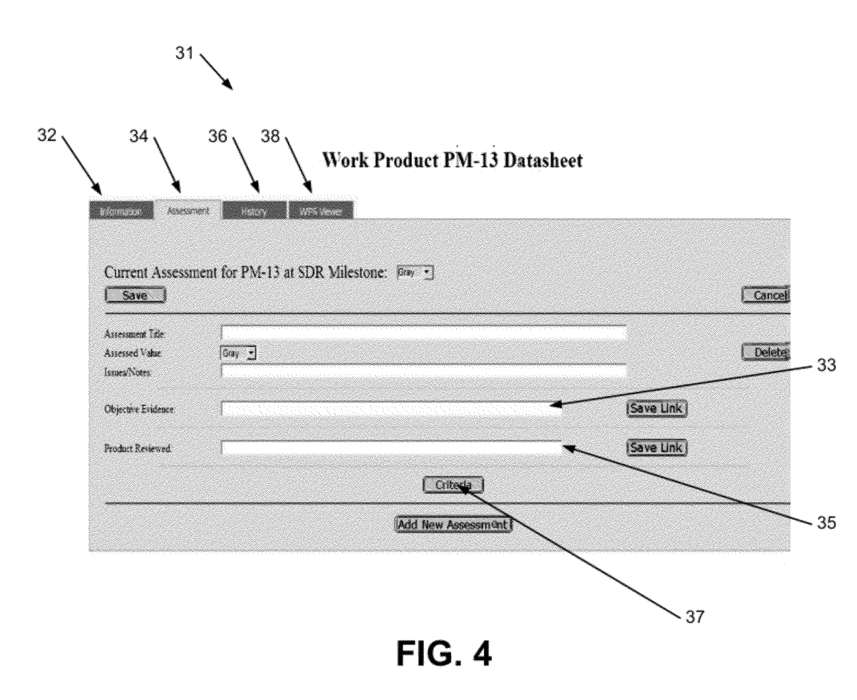

FIG. 4 shows information depicted when the assessment tab 34 of the work product datasheet 31 is selected. The assessment tab 34 allows an assessment of the base-level task 30 to be stored and reviewed by other users. For instance, objective evidence 33, such as a document or file, may be linked to via the assessment tab 34 to allow a user to quickly locate and review the material that forms the basis for the assessment of the base-level task 30. Further, the assessment tab 34 also allows material reviewed 35 during the assessment to be linked to the assessment tab 34. This way, a user may quickly locate and review both the material that was evaluated and the result of the evaluation. Further, assessment criteria 37 may also be linked to via the assessment tab 34. Thus, a user may view the standard that the material reviewed 35 was to satisfy by viewing the assessment criteria 37.

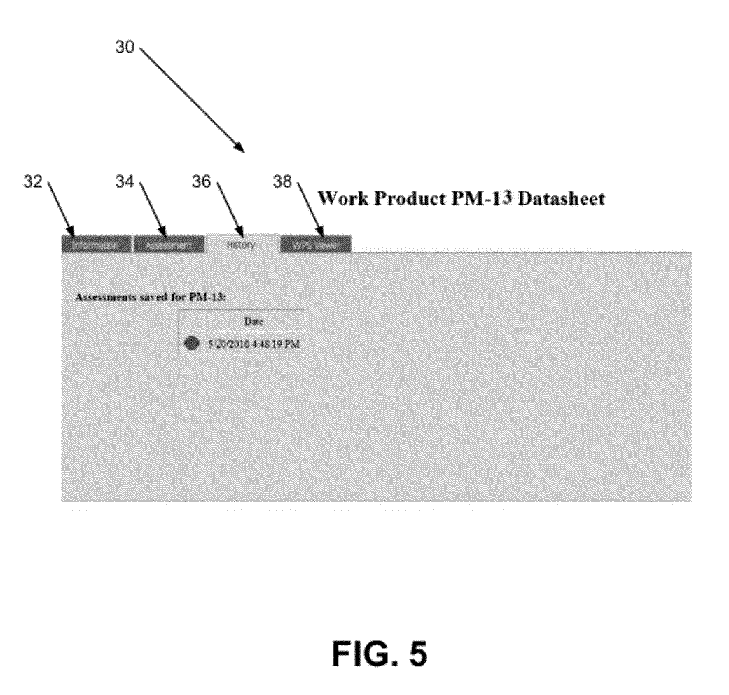

A history tab 36 is depicted in FIG. 5. The history tab 36 allows a user to view previous evaluations of the base-level task 30. The history tab 36 allows a user to track the progress and evaluations of the base-level task 30 over the courses of the project, such as allowing the user to view if the base-level task 30 has historically failed to meet standards for the assessment criteria 37, or if the base-level task 30 has historically met standards for the assessment criteria 37, or has, like many project tasks, fluctuated between meeting the standards of the assessment criteria 37 and failing to meet the standards of the assessment criteria 37 over the course of the projects.

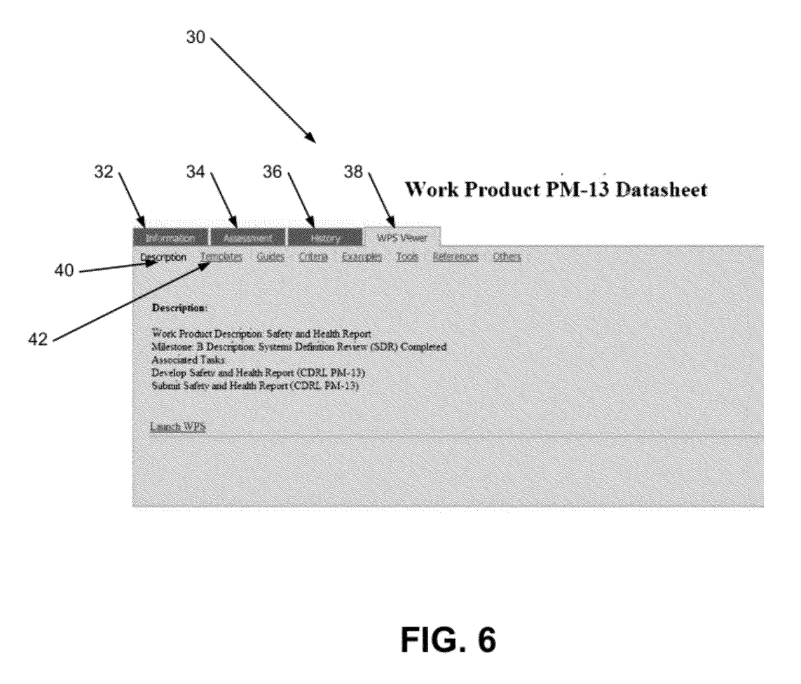

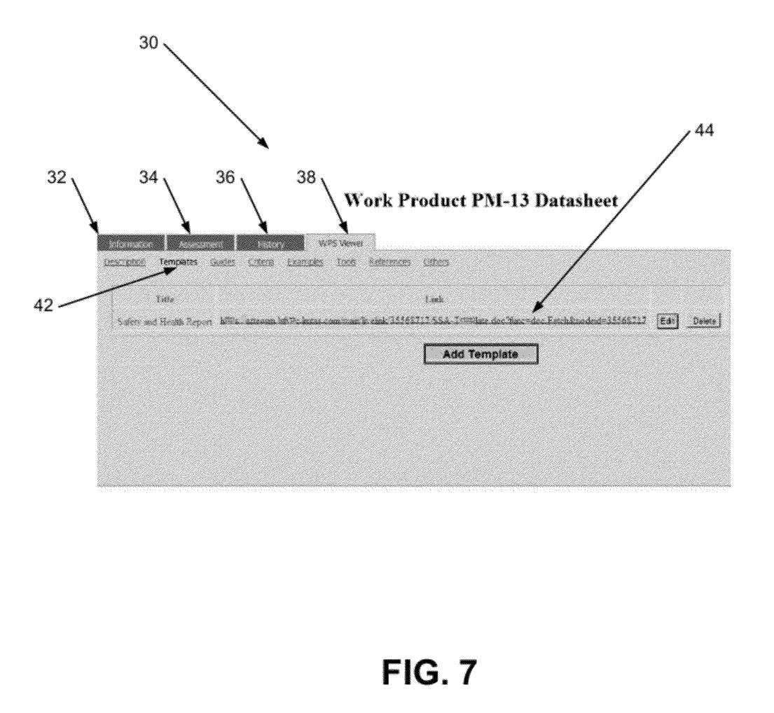

FIG. 6 shows the WPS viewer tab 38 according to one embodiment. The WPS viewer tab 38 may have a plurality of sub-tabs, such as an information tab 40 and a templates tab 42. The information tab allows a user to view a description of the base-level task 30. FIG. 7 depicts the template tab 42 that allows a user to access a link 44 to a template that may be used to document the evaluation of the base-level task 30.

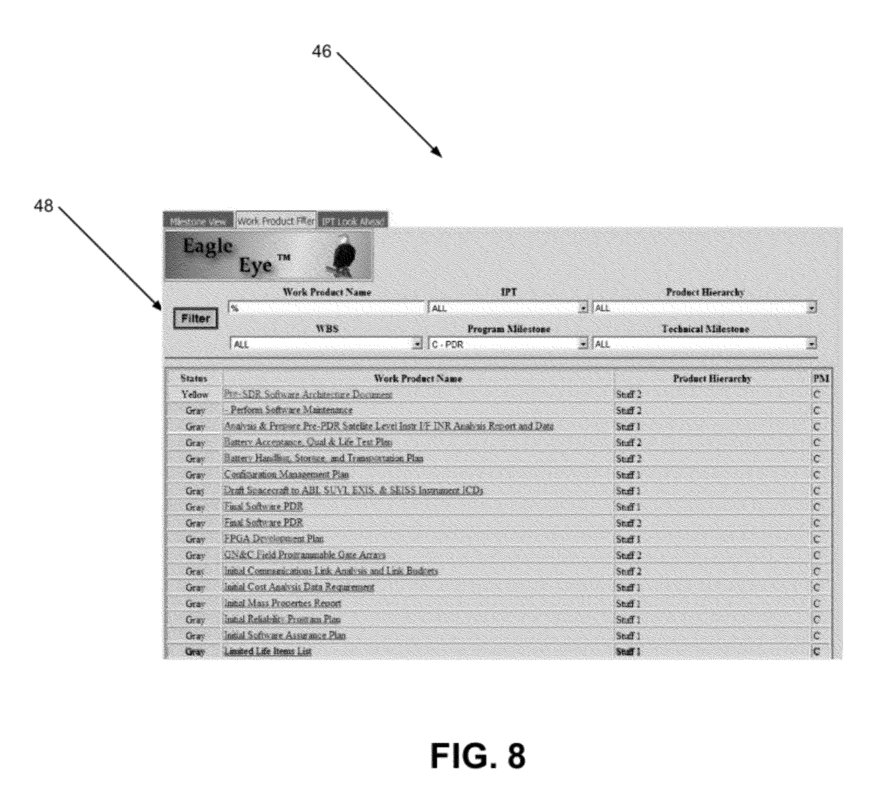

A Work Product Filter 46 is depicted in FIG. 8. The work product filter 46 allows a user to filter the information within the tool based upon a number of factors. The filter may have the capability to search by work product name, IPT, Product Hierarchy, WBS, Program Milestones, and Technical Milestones. The work product filter 46 allows a user to quickly view the status of any tasks that are not fully compliant with standards for that task. For instance, as shown in FIG. 8, the top task has a yellow status, indicating that the task is minimally compliant with the standards for that task. The work product filter 46 thus allows a user to quickly sort data within the tool based on a number of different criteria.

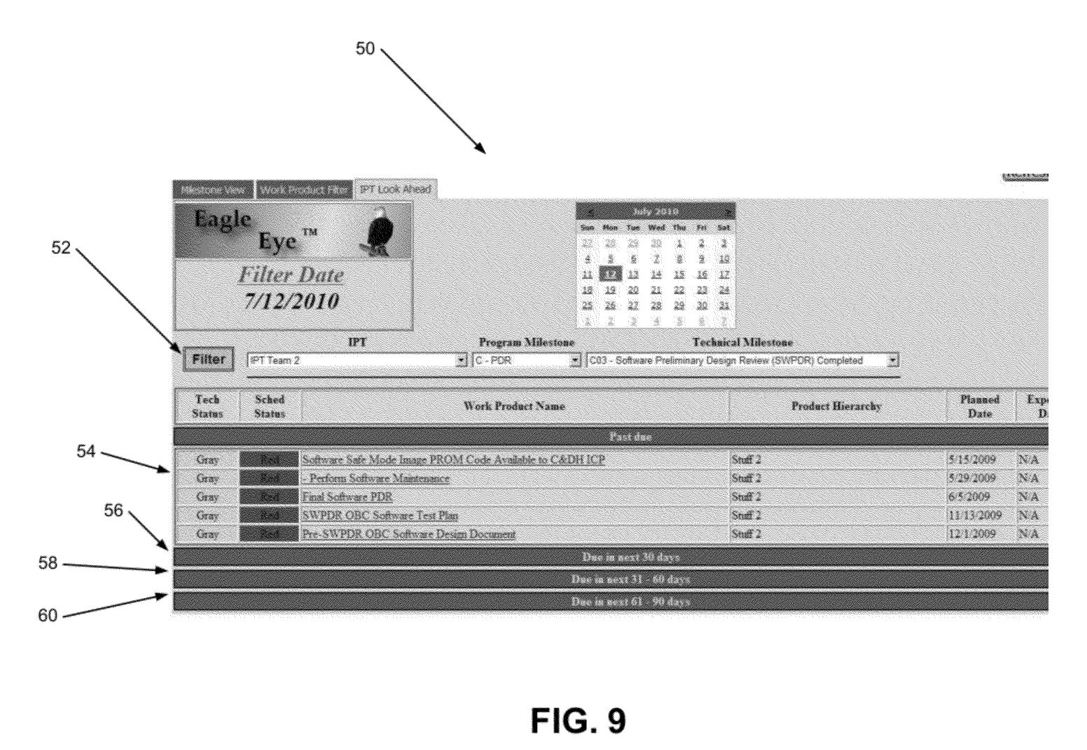

FIG. 9 shows an IPT look ahead 50. The IPT look ahead 50 allows a user to order data within in the tool based on a schedule for a project or task. For instance, a filter 52 may be used to sort tasks by program milestones, technical milestones, or simply based on the calendar. Tasks that are past due 54 may be shown at the top of the results to indicate to the user that these tasks have yet to be satisfactorily completed. Additional tasks may be filtered based on upcoming due dates, such as those tasks due within the next thirty days 56, tasks due within the next sixty days 58, and tasks due within the next ninety days 60. The IPT look ahead 50 allows a user to quickly see an amount of work that needs to be completed within a set time period, so that resources may be scheduled to meet the deadlines for the tasks.

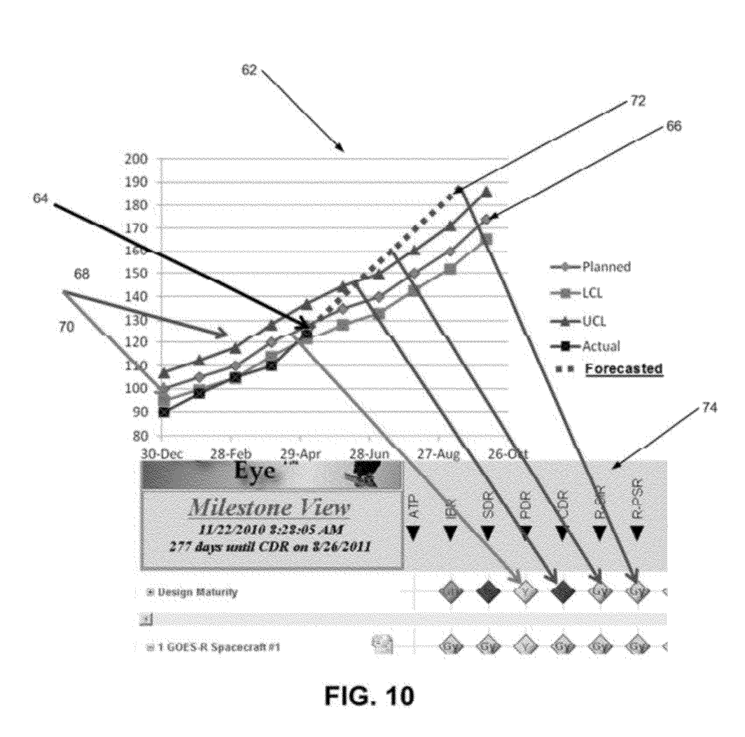

A process metrics milestone view 74 is shown in FIG. 10 that displays status based on process metrics Process metrics can include technical performance measures, key performance measures, earned value measures, or in general, any measures that are periodically taken and compared to historical values from similar projects. This view can be a section of normal milestone view based on design maturity 10 or could be individually displayed. The process metrics milestone view 74 provides hyperlinks to a graphical display 62 of execution for the process metric milestone view 74. The graphical display 62 charts the actual technical performance progress of the project 64 against a planned project technical process rate 66. An upper control limit and a lower control limit 68, 70 are utilized in connection with the actual progress 64 to generate a forecast 72 of future project completion. The upper control limit 68 and the lower control limit 70 may be developed based on past experience with similar projects for the rate that technical projects may be completed, so that the forecast 72 can be as accurate as possible. The colors on the process metrics milestone view 74 may be based on whether the actual technical progress 64 or the forecast technical progress 72 lie within (or within an allowable threshold) of the control limits 68, 70 at the planned date for the displayed milestone.

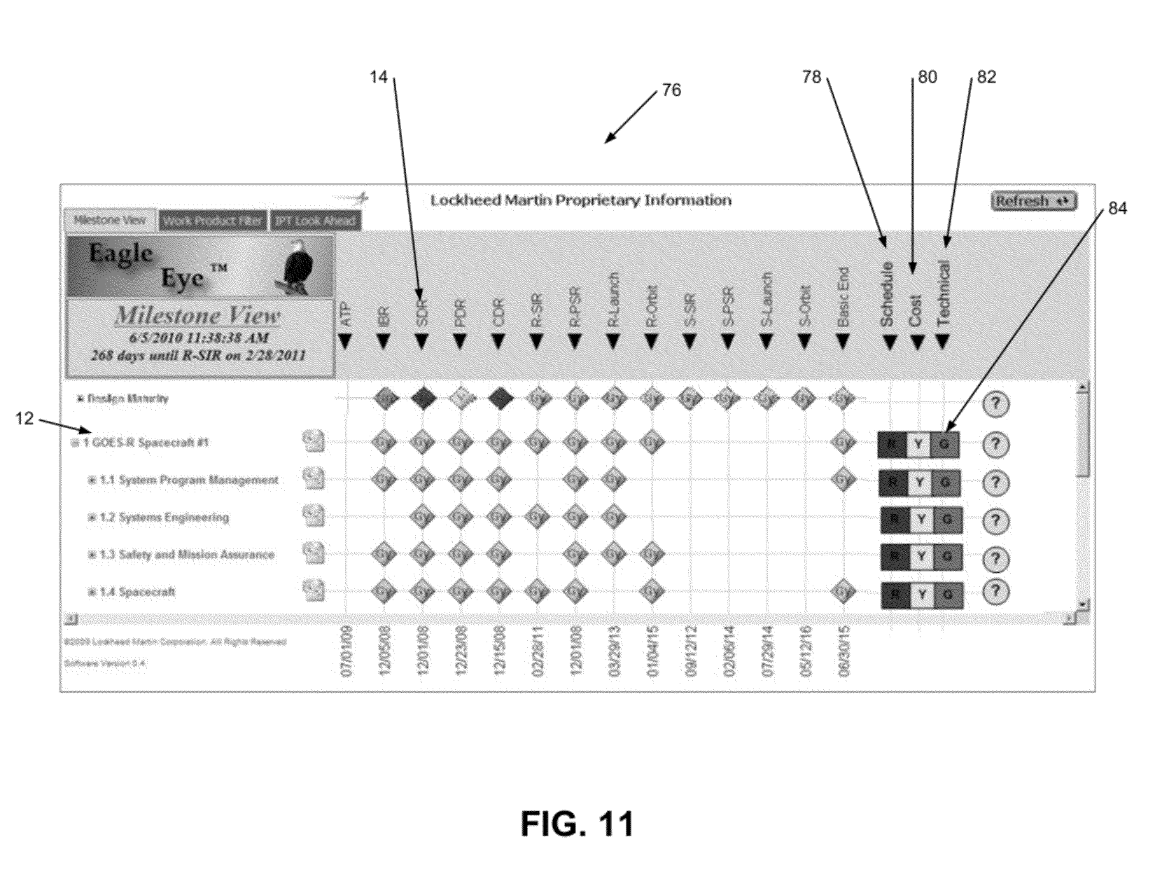

FIG. 11 depicts an alternate embodiment of a program milestone view 76 that is similar to the program milestone view 10 shown in FIG. 1, but includes additional information, such as schedule status 78, cost status 80, and technical status 82. The schedule status 78, cost status 80, and technical status 82 are shown for each of the tasks or projects 12. A status indicator 84 may be provided for each of the schedule status 78, cost status 80, and technical status 82 for each of the hierarchical tasks 16. Thus, a user may quickly be able to evaluate whether a task 16 is on budget based on a color of the status indicator 84 in the cost status 80 column, is on schedule based on a color of the status indicator 84 in the schedule status 78 column, and if the technical aspects of a project are satisfied based on a color of the status indicator 84 in the technical status 82 column. Hyperlinks may be provided at each status indicator 84 to allow a user to observe additional information relating to the schedule status 78, cost status 80, and technical status 82 for each of the hierarchical tasks 16.

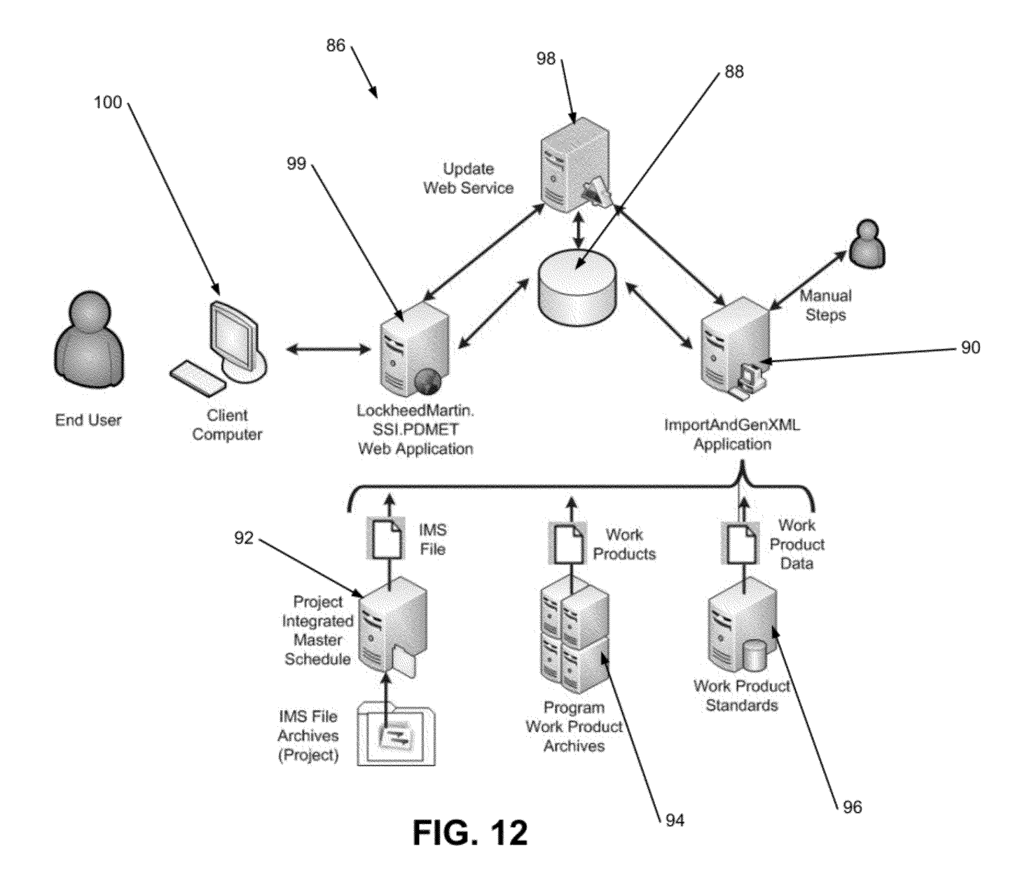

FIG. 12 shows a system 86 for providing a hierarchical project evaluation tool described above and in connection with the preceding figures. The system 86 comprises a data repository 88 that is connected to a number of additional network resources described herein. The data repository 88 may allow for storage of files directly on the data repository 88 that may be accessed in order to display information related to the hierarchical tasks 16, such as technical maturity. Alternatively, or in addition to storing at least some files on the data repository 88, the data repository 88 may link to other network resources that store files. The data repository 88 is linked to a file importation and conversion device 90. The file importation and conversion device 90 may contain source code that allows for various file types to be accessed from the data repository 88. The file importation and conversion device 90 may convert disparate file types into a format that can be stored in the data repository 88, or more commonly the file importation and conversion device 90 may contain conversion instructions that allow the access of files from the data repository 88 of many different types by running certain file conversion algorithms.

A project integrated master schedule 92 is typically the basis for all other information located on or accessed by the data repository 88. The project integrated master schedule (IMS) 92 may be created in a commercially available project management software, such as Microsoft Project, Microsoft Excel, Oracle Primavera, Deltec Open Plan, and others. Once the IMS 92 is imported to the data repository 88 an algorithm may be run by the file importation and conversion device 90 to verify the data of the IMS 92 is complete, such that there are no missing successor links for project tasks, that tasks and work product names are specified, and tasks are properly linked to milestones. The file importation and conversion device 90 may also associate project IMS 92 task work products to program milestones based on the predecessor/successor relations contained in the master schedule.

An administrator may also review the IMS 92 once it has been communicated to the data repository 88 in order to observe any additional errors in the IMS 92, or problems with the communication of the IMS 92 to the data repository 88. Correcting any deficiencies with the IMS 92 before the project has advanced beyond the initial planning stages may greatly improve overall project performance.

A work product archive 94 is also in communication with the conversion device 90 and the data repository 88. The work product archive 94 may be configured to store information related to tasks 16 and milestones 14 of a project. For instance, the work product archive 94 may contain records generated in performing a task, such as software code, product design information, CAD models, presentations, and the like. The work product archive 94 may thus be utilized to store information for each task 16 of the project. The file importation and conversion device 90 may access the data stored on the work product archive 94 to allow a user to review the work product, such as by selecting a hyperlink related to the task 16.

A work standards archive 96 is also in communication with the file importation and conversion device 90 and the data repository 88. The work standards archive 96 may contain information about tasks 16 and milestones 14 of a project, such as customer requirements for a task, design standards for a task, cost requirements for a task, technical specifications for a task, and internal company standards and procedures for a task. The file importation and conversion device 90 may access the data stored on the work standards archive 96 to allow a user to evaluate standards for a project. For instance, a design engineer may access the work standards archive 96 in order to determine capabilities of a product he or she is designing. Similarly, a person tasked with evaluating a completed design may access both the work product archive 94 to view the design and related information, and the work standards archive 96 in order to properly determine if the design meets all required criteria.

The system 86 further comprises a web server 99. The web server 99 may be in communication with the data repository 88 and the file importation and conversion device 90. The web server 99 may also contain a version of the application found on the data repository 88 to allow access to the various data stored on the data repository 88.

An assessment application 98 may also be provided that is in communication with the web server 99 and the data repository 88. The assessment application 98 may be provided at a different location from the web server 99 and the data repository 88. The assessment application allows for inputting of work product assessment data and performs processing to determining task status associated with the assessment data. When a new or modified assessment is communicated to the assessment application 98, the status of all associated tasks within the data repository 88 are updated and made available for display by the web server 99.

A local computer 100 is in communication with the local network server 99. The local computer allows a user to access the data repository 88 and run the hierarchical project evaluation tool and to access the data stored in the IMS 92, the work product archive 94, and the work standards archive 96. The user may then create additional work product that may be stored in the IMS 92, the work product archive 94, and the work standards archive 96. Further the user may quickly view the overall status of the project based on the program milestone view 10, as shown in FIG. 1, the icon view as shown in FIG. 2. Further the user may obtain details of specific tasks 16 to determine any work that they must perform in order to complete the task 16, and may also review the standards regarding the evaluation criteria for the task 16. Further, once a user completes the task 16, the user may also review the evaluation of that task 16 in order to determine if any additional or corrective action is required.

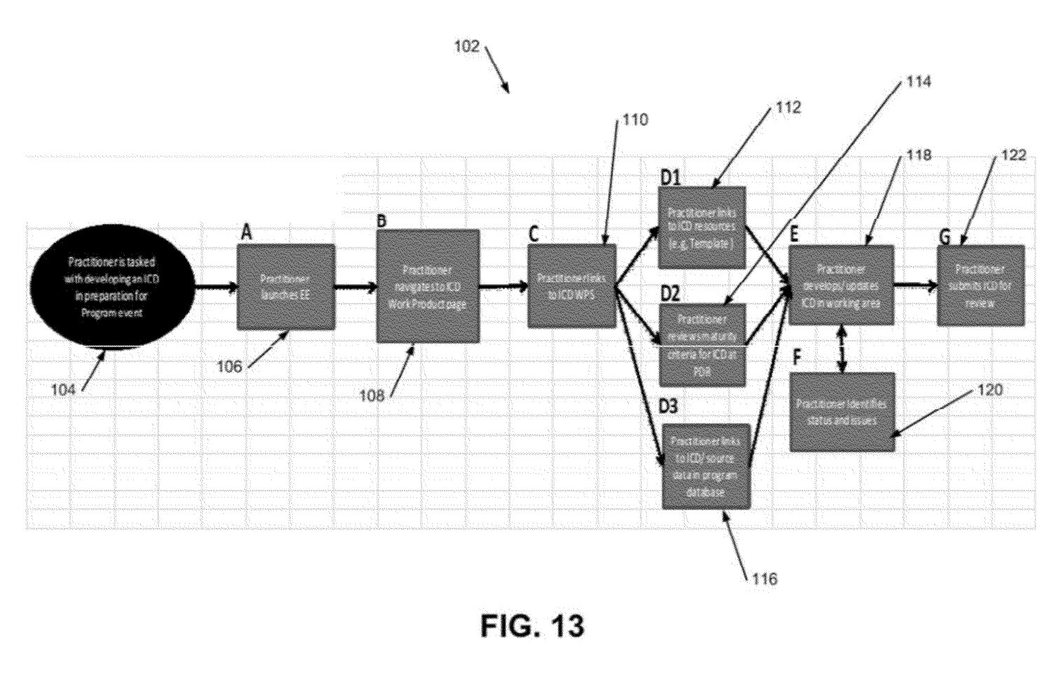

Turning now to FIG. 13, a method 102 is depicted for developing an interface control document (ICD), a particular task for a project, using the hierarchical project evaluation tool. As shown at block 104, a user is first assigned a task of creating an ICD for a particular milestone 14 with the hierarchical project evaluation tool. The user launches the hierarchical project evaluation tool at block 106. The user navigates within the hierarchical project evaluation tool to an ICD work product page at block 108. Next, the user links the ICD work product page to a WPS for the ICD at block 110. The user will link ICD resources, such as a template, to the ICD work product page at block 112. Block 114 shows that the user links criteria to the ICD work product page for a milestone, such as a preliminary design review. The user also generates a link to ICD source data at block 116. At block 118, the user develops and updates the actual ICD work product in a working area that is also linked to the ICD WPS. Block 120 depicts the user evaluating the status of the ICD based on the criteria from block 114. Finally, as shown at block 122, the user submits the ICD for further review by other evaluators.

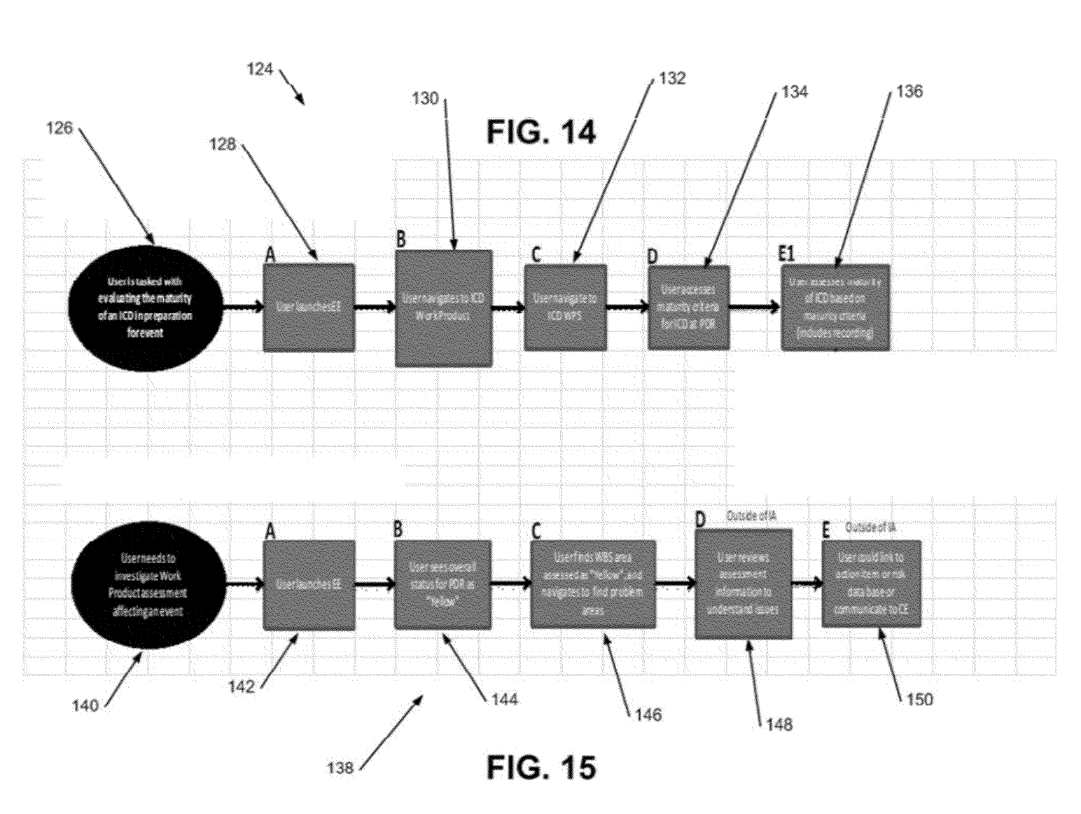

FIG. 14 shows a method 124 of using the hierarchical project evaluation tool to assess work product for a task. As shown at block 126, a user is first assigned a task of evaluating an ICD for a particular milestone 14 with the hierarchical project evaluation tool. The user launches the hierarchical project evaluation tool at block 128. The user navigates within the hierarchical project evaluation tool to an ICD work product page at block 130. The user navigates to the WPS for the ICD, as shown at block 132. The user reviews the evaluation criteria for the ICD at block 134. The user generates an assessment of the ICD at block 134 and records this information in the hierarchical project evaluation tool to create a record of the assessment at block 136.

FIG. 15 depicts a method 138 of using the hierarchical project evaluation tool to investigate a work product assessment for a task. As shown at block 140, a user is first assigned a task of investigating an assessment related to a task for a particular milestone 14 with the hierarchical project evaluation tool. The user launches the hierarchical project evaluation tool at block 142. The user navigates within the hierarchical project evaluation tool to a page showing program milestone view at block 144 and notices a task evaluated as having a yellow status as described above. The user navigates to the WPS for the task identified as having a yellow status 146. The user reviews the assessment of the task having the yellow status by utilizing a hyperlink within the hierarchical project evaluation tool at block 148. The user may then generate additional work product or an additional evaluation to indicate that corrective action needs to be taken on this task, or the user may notify others that corrective action needs to be taken at block 150.

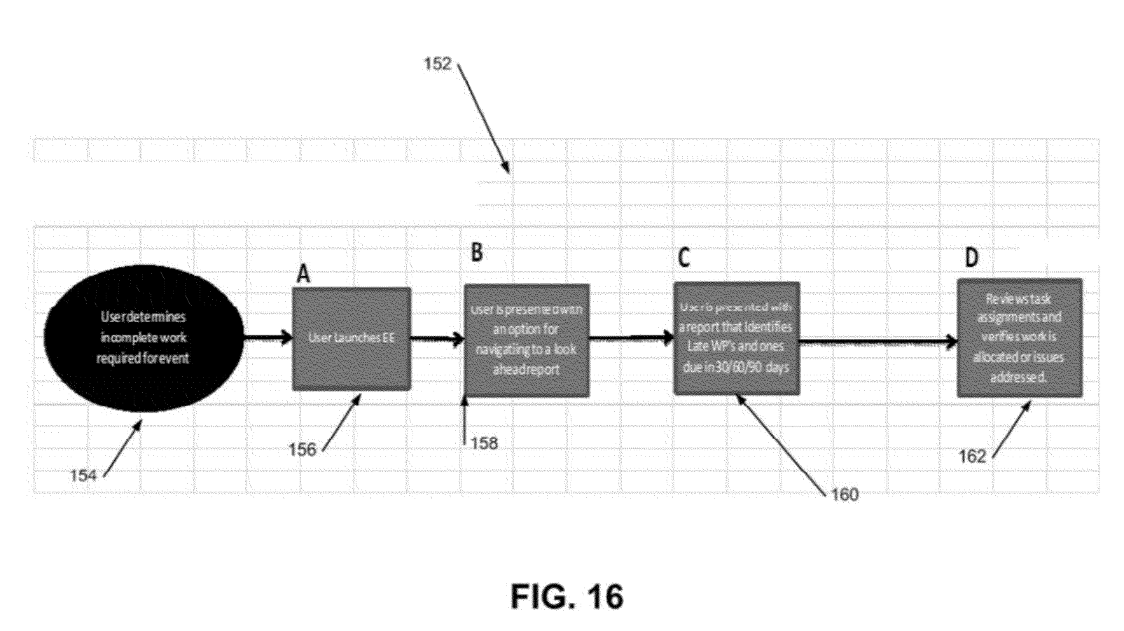

FIG. 16 depicts a method 152 of using the hierarchical project evaluation tool to determine tasks in need of completion on a project. As shown at block 154, a user is first assigned a task of investigating incomplete tasks related to a particular milestone 14 with the hierarchical project evaluation tool. The user launches the hierarchical project evaluation tool at block 156. The user navigates within the hierarchical project evaluation tool to a page showing a look ahead list of tasks at block 158. The user observes a report showing tasks past due, and those with due dates at various future dates, such as within thirty days, within sixty days, and within ninety days at block 160. The user reviews the due dates for the tasks and verifies work is allocated for the tasks at block 162.

In order to provide additional instructions to a user, it is contemplated that a help page or a web based help or instruction page may be provided. The web based help or instruction page may be a “wiki” in that users may provide comments and information to other fellow users that may be useful for the operation of the technical maturity management system.

It is further contemplated that a project administrator may create and maintain a hierarchical project evaluation tool. The administrator may create a new project on a web server and import relevant technical requirement and evaluation criteria to the web server or a data repository and ensure that the hierarchical project evaluation tool is being utilized by members of a technical program to evaluate the technical status of the program. The administrator can also verify the status information by reviewing assessment data and project standards data. The administrator may also control any updates to the hierarchical project evaluation tool, such as new software releases. Thus, the hierarchical project evaluation tool may be maintained completely by members of program team without the need for extensive outside information technology resources.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

Electronic hardware used to implement the various illustrative blocks, modules, elements, components, methods, and algorithms may include a processor configured to execute one or more sequences of instructions or code stored on computer/machine readable media. The processor may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. The electronic hardware may further include a memory, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to a bus for storing information and instructions to be executed by a processor.

The algorithm may be implemented by a processor executing one or more sequences of instructions or code contained in a memory. Such instructions may be read into the memory from another machine-readable medium. Execution of the sequences of instructions contained in the memory may cause the processor to perform the process steps described herein. One or more processors in a multi-processing arrangement may also be employed to execute the sequences of instructions contained in the memory. In alternative embodiments, hard-wired circuitry may be used in place of or in combination with software instructions to implement various embodiments of the present disclosure. Thus, embodiments of the present disclosure are not limited to any specific combination of hardware circuitry and software.

The term “machine-readable medium” or “computer-readable medium” as used herein refers to any medium or media that participates in providing instructions to a processor for execution. Such a medium may take many forms, including, but not limited to, non-volatile media, volatile media, and transmission media. Non-volatile media include, for example, optical or magnetic disks. Volatile media include dynamic memory. Transmission media include coaxial cables, copper wire, and fiber optics, including the wires that comprise a bus. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer or processor can read.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public. Furthermore, to the extent that the term “include,” “have,” or the like is used in the description, such term is intended to be inclusive in a manner similar to the term “comprise” as “comprise” is interpreted when employed as a transitional word in a claim.

What is claimed is:

1. A system for technical maturity management comprising:
a web based hierarchical project evaluation application having:
a project milestone display having a plurality of rows of project tasks and a plurality of columns of project milestones, a status indicator to provide a technical status indicating a completion level of the project task for each applicable project milestone;
a hierarchical display for the plurality of project tasks, the project tasks being expandable to show lower level tasks associated with the project task, each of the project tasks having a technical status indicator to provide the technical completion level of the project task; and
a work product status viewer for each of the plurality of project tasks providing technical assessment status information.

2. The system for technical maturity management of claim 1, wherein the web based hierarchical project evaluation application further has a look ahead display providing a listing of tasks based on due dates associated with the tasks.

3. The system for technical maturity management of claim 1, wherein the web based hierarchical project evaluation application further has a work product filter display to display projects based on status of the project.

4. The system for technical maturity management of claim 1, wherein the additional information regarding the task comprises technical requirements for the task.

5. The system for technical maturity management of claim 1, wherein the additional information regarding the task comprises assessment standards for the task.

6. The system for technical maturity management of claim 1, wherein the additional information regarding the task comprises assessments performed relating to the task.

7. The system for technical maturity management of claim 1, wherein the work product status viewer has a plurality of selectable tabs or hyperlinks to provide additional work product or assessment information.

8. The system for technical maturity management of claim 7, wherein one of the plurality of selectable tabs or hyperlinks of the work product status viewer is an assessment history tab showing a previously made assessment of the task.

9. The system for technical maturity management of claim 7, wherein one of the plurality of selectable tabs or hyperlinks of the work product status viewer is a work product standards tab.

10. The system for technical maturity management of claim 9, wherein the work products standards tab includes hyperlinks to at least one of a template for work product related to the task, evaluation criteria for the task, and technical requirements for the task.

11. The system for technical maturity management of claim 1, further comprising a process metrics milestone display having a graphical display charting actual and predictive technical performance progress of a milestone against a planned project technical process rate for the milestone.

12. The system for technical maturity management of claim 1, further comprising a hyperlink being provided for each project task to provide additional information regarding the task in at least one of the project milestone display and the hierarchical display for the plurality of project tasks.

13. A system for providing a hierarchical project technical evaluation tool comprising:
an application for obtaining technical assessment data for work products of a project and storing the technical assessment data to a data repository;
a hierarchical project evaluation tool application generating a project technical status based on the assessment data in the data repository, the hierarchical project technical evaluation tool application in communication with the data repository;
a file importation and conversion device in communication with the data repository, the file importation and conversion device converting data files to a useable format within the hierarchical project evaluation tool application; and
a project integrated master schedule in communication with the file importation and conversion device and providing data to the data repository for use with the hierarchical project evaluation tool application, the project integrated master schedule having a plurality of tasks to be completed for a project and a plurality of milestones for the project.

14. The system for providing a hierarchical project technical evaluation tool of claim 13 further comprising a work product archive in communication with the data repository and providing data to the hierarchical project evaluation tool application, the work product archive storing information related to the plurality of tasks and the plurality of milestones for the project.

15. The system for providing a hierarchical project technical evaluation tool of claim 13 further comprising a work standards archive in communication with the data repository and providing data to the hierarchical project evaluation tool application, the work standards archive storing information about tasks and milestones requirements for the project.

16. The system for providing a hierarchical project technical evaluation tool of claim 13, wherein the project integrated master schedule is generated in a commercial project management tool.

17. The system for providing a hierarchical project technical evaluation tool of claim 13, wherein the information about tasks and milestones requirements for the project includes customer requirements for a task.

18. The system for providing a hierarchical project technical evaluation tool of claim 13, wherein the information about tasks and milestones requirements for the project includes design standards for a task.

19. The system for providing a hierarchical project technical evaluation tool of claim 13, wherein the information about tasks and milestones requirements for the project includes cost limits for a task.

20. The system for providing a hierarchical project technical evaluation tool of claim 13, wherein the information about tasks and milestones requirements for the project includes internal company procedures for a task.

21. The system for providing a hierarchical project technical evaluation tool of claim 13, wherein the data repository maps project integrated master schedule tasks to assessment data.

22. The system for providing a hierarchical project technical evaluation tool of claim 21, wherein the mapping of the project integrated master schedule tasks to assessment data is used to determine the technical status of the integrated master schedule task.

23. A computer-readable medium having software instructions stored thereon, the software instructions, when executed by a processor, cause the processor to perform operations comprising:
generating a project milestone display having a plurality of project tasks and a plurality of project milestones;
receiving a technical assessment for each of the project tasks; and
providing a technical status indicator for each of the plurality of project tasks based upon the technical assessment for each of the project tasks.

24. The computer-readable medium of claim 23, further comprising:
providing access to evaluation criteria for each of the projects tasks.

25. The computer-readable medium of claim 23, further comprising:
providing a technical status indicator at predefined technical milestones for each of the plurality of project tasks based on a predecessor and successor task relationship imported from an integrated master schedule and the technical assessment for each of the project tasks.

26. The computer-readable medium of claim 23, further comprising:
generating a hierarchical task display for the plurality of project tasks, the project tasks being expandable in the hierarchical task display to show lower level tasks associated with the project task, each of the project tasks having a status indicator to provide the status of the project task.

27. The computer-readable medium of claim 26, wherein the hierarchical task display further includes a hyperlink provided for each project task to link to additional information regarding the task.

28. The computer-readable medium of claim 23, further comprising:
generating a work product data sheet viewer for each of the plurality of project tasks having a plurality of selectable items to provide additional information about the project task including at least an assessment item for the project task.
